(19) United States
(12) Patent Application Publication
(10) Pub. No.: US 2010/0186192 A1
(43) Pub. Date: Jul. 29, 2010

(54) Wheel construction, particularly for furniture and furnishing pieces and trolleys

(75) Inventor: RUGGERO TRIVINI, S.ANGELO LODIGIANO (LODI) (IT)

Correspondence Address: HEDMAN & COSTIGAN, P.C., 1230 AVENUE OF THE AMERICAS, 7th floor, NEW YORK, NY, 10020, US

(73) Assignee: O.G.T.M. OFFICINE MECCANICHE S.R.L., S.ANGELO LODIGIANO (LODI) (IT)

(21) Appl. No.: 12/586,217

(22) Filed: Sep. 18, 2009

(30) Foreign Application Priority Data
Jan. 23, 2009 (IT) MI2009A 000076

(51) Int. Cl. B60B 37/10

(52) U.S. Cl. 16/25; 16/31 R

(57) ABSTRACT

The present invention relates to a wheel construction, particularly for furniture and furnishing pieces and trolleys, comprising a box-like body including two half-shells which can be coupled to one another and defining a cylindric hub, rotatably supporting an annular band defining the wheel sliding surface.

### BACKGROUND OF THE INVENTION

The present invention relates to a wheel construction, particularly for furniture and furnishing pieces and trolleys and the like.

As is known, wheels conventionally used for furniture and furnishing pieces, trolleys and the like, generally comprise a pivot pin operating as a rotary seat for a wheel which has a wheel configuration depending on the user requirements.

In this construction, the assembling of the wheel is a comparatively complex operation, since the shaft has a small size and, accordingly, it is necessary to adopt further structural auxiliary means for properly supporting the wheel.

### SUMMARY OF THE INVENTION

Accordingly, the aim of the present invention is to solve the above mentioned problem, by providing a wheel construction, specifically designed for furniture and furnishing pieces, trolleys and the like, allowing to include therein a comparatively large size hub, while providing a very compact wheel construction, thereby facilitating the assembling of said wheel even in a non exposed to the view assembling application.

Within the scope of the above mentioned aim, a main object of the invention is to provide such a wheel construction which can be easily and quickly assembled, without requiring special surface machining operations.

Another object of the present invention is to provide such a wheel construction which, owing to its specifically designed structural features, is very reliable and safe in operation.

Yet another object of the present invention is to provide such a wheel construction for furniture and furnishing pieces, trolleys and the like, which can be easily made starting from easily available elements and materials and which, moreover, is very competitive from a mere economic standpoint.

According to one aspect of the present invention, the above mentioned aim and objects, as well as yet other objects, which will become more apparent hereinafter, are achieved by a wheel construction for furniture and furnishing pieces, trolleys and the like, characterized in that said wheel construction comprises a box-like body including two half-shells adapted to be coupled to one another and defining a cylindric hub rotatably supporting an annular band providing a wheel sliding surface.

### BRIEF DESCRIPTION OF THE DRAWINGS

Further characteristics and advantages of the present invention will become more apparent hereinafter from the following detailed disclosure of a preferred, though not exclusive, embodiment of a wheel construction specifically designed for furniture and furnishing pieces, trolleys and the like, which is illustrated, by way of an indicative, but not limitative example, in the accompanying drawings, where:

FIG. 1 is an exploded perspective view showing the wheel construction according to the present invention;

FIG. 2 shows the wheel construction according to the invention with the two half-shells thereof shown in an exploded form;

FIG. 3 is a further perspective view showing the wheel construction in an assembled condition thereof;

FIG. 4 is a further perspective view showing the inventive wheel construction in a braking position thereof;

FIG. 5 is a front view showing the wheel construction in an operating condition thereof;

FIG. 6 is a cross-sectional view, taken along a plane perpendicularly to the wheel construction rotary axis, showing said wheel construction in an operating condition thereof;

FIG. 7 is a front view showing the inventive wheel construction in a braking condition thereof;

FIG. 8 is yet another cross-sectional view, taken along a plane perpendicularly to the wheel axis, showing the wheel construction in a braking condition thereof; and

FIG. 9 shows the wheel construction in an open condition thereof, to clearly illustrate the structure of the two half-shells forming the box-like construction of the wheel.

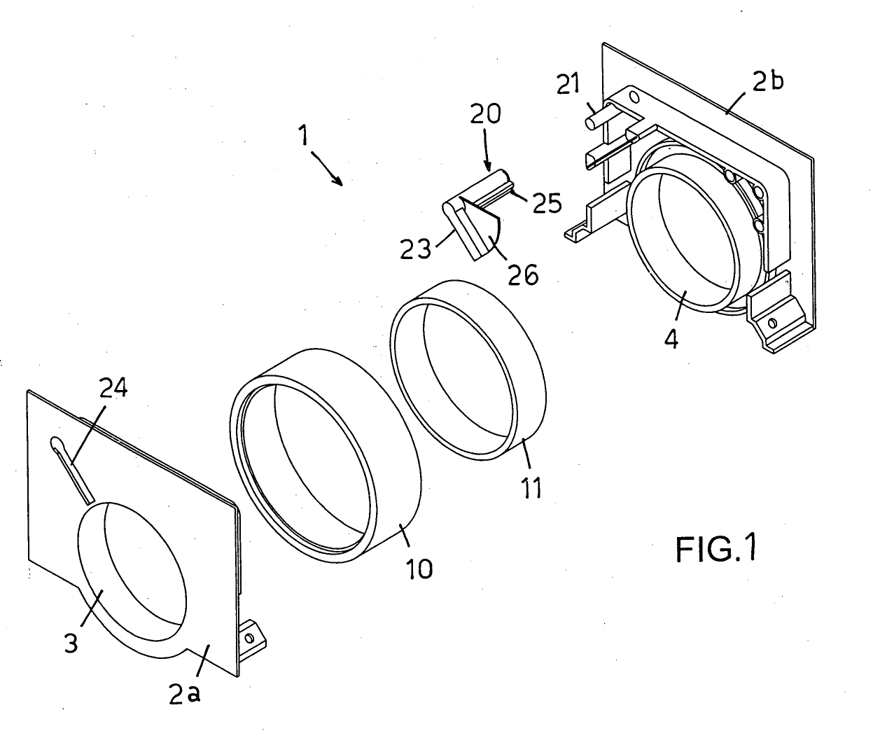

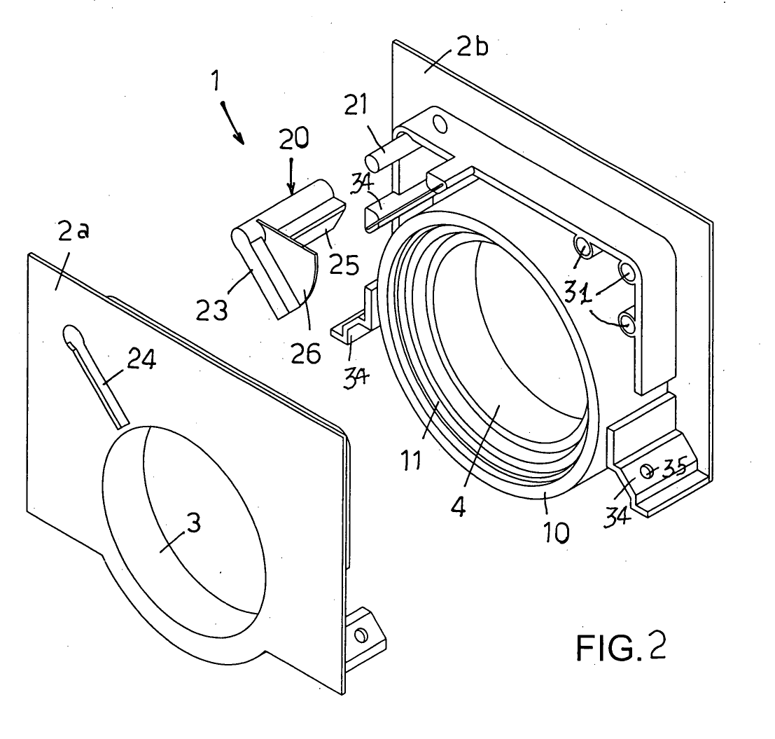

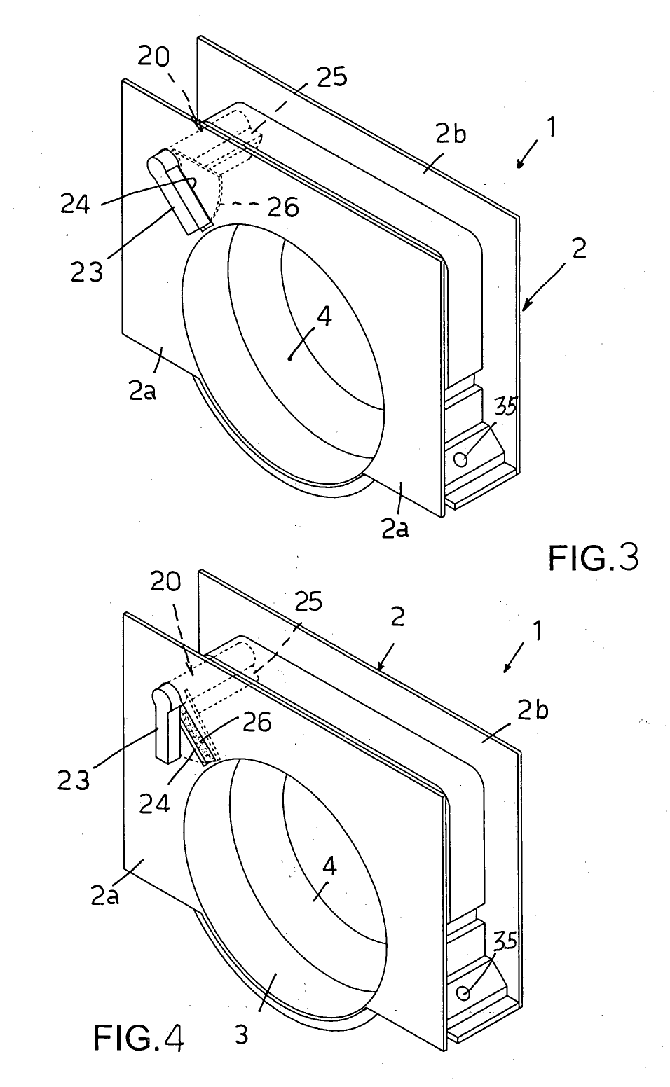

### DESCRIPTION OF THE PREFERRED EMBODIMENTS

With reference to the number references of the above mentioned figures, the wheel construction, specifically designed for furniture and furnishing pieces, trolleys, and the like; which has been generally indicated by the reference number 1, comprises a box-like body 2 consisting of two body half-shells and, more specifically, a first male half-shell 2a including projecting pegs 30, and a second half-shell 2b including corresponding seats or recesses for housing said projecting pegs 30, which respectively define a first half-hub 3 and a second half-hub 4.

The latter are arranged in a mutual alignment relationship, thereby providing a hub assembly thereon can be rotatably supported an annular band 10, providing the wheel construction sliding element.

The projecting pegs or pins 30, in turn, are adapted to engage, as the wheel construction is assembled, in the corresponding seats or recesses 31, thereby firmly coupling the two male 2a and female 2b half-shells.

The pegs 30 have a slightly conical configuration and, as they are engaged in their housing recesses 31, provide, because of a clamping mechanical action of two like materials, a firm locking of said male 2a and female 2b half-shells.

Thus, the wheel construction 1 can be assembled in a much more quick and easy manner than a prior wheel construction.

In addition, the wheel assembling does not require to use assembling screws or specifically designed tools.

In this connection it should be pointed out that the male half-shell 2a further comprises projecting elements 33, having any desired suitable configurations, operating as abutment elements adapted to slide, and engage, in turn, on contoured projecting elements 34 thereby further stabilizing the two male 2a and female 2b half-shells.

More specifically, said contoured projecting elements 33 and 34 comprise respective holes 35 for engaging therein corresponding clamping screws, for clamping the wheel construction to the furniture piece (not shown).

Said clamping screws, moreover, provide a further locking element for properly locking the two half-shells 2a and 2b.

As shown, between the hub formed by said half-hubs 3 and 4 and said annular band 10, an anti-friction ring 11, facilitating the rotary sliding of the annular band, is arranged.

Moreover, the wheel construction further comprises braking means, formed by a braking element, generally indicated by the reference number 20, which is rotatably supported by a small peg 21 defined by one of said half-shells, for example the half-shell 2b, and including an operating lever 23 projecting from a slot 24 formed on the other of said half-shells.

As shown, the braking element comprises a cam portion 25 and an indicating band 26 which is advantageously colored in red and can be seen from the slot 24.

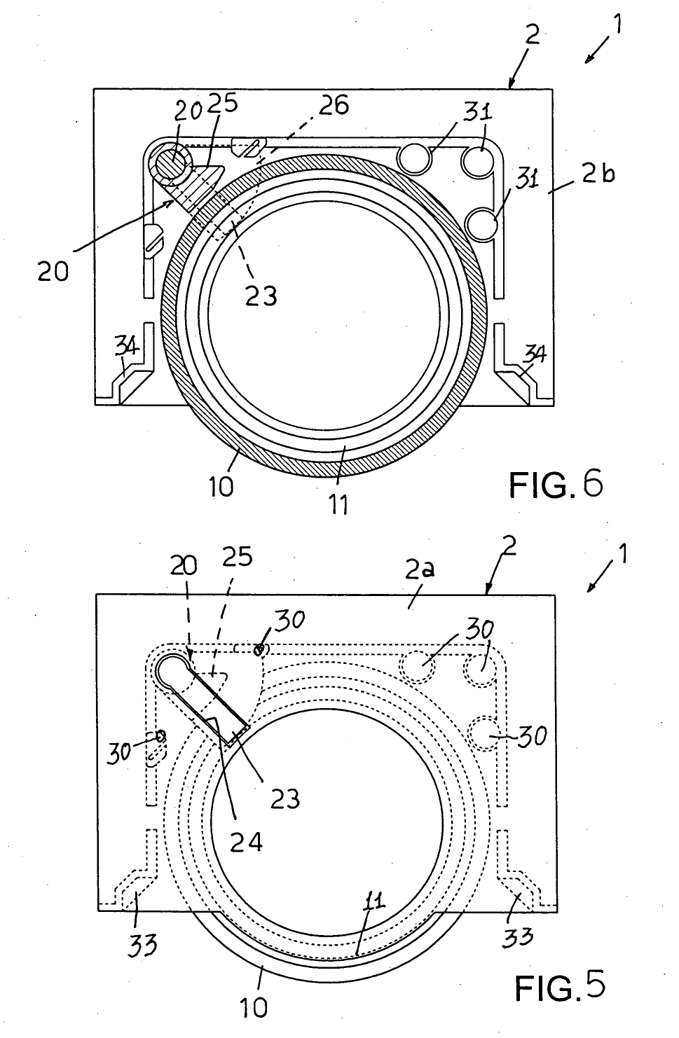

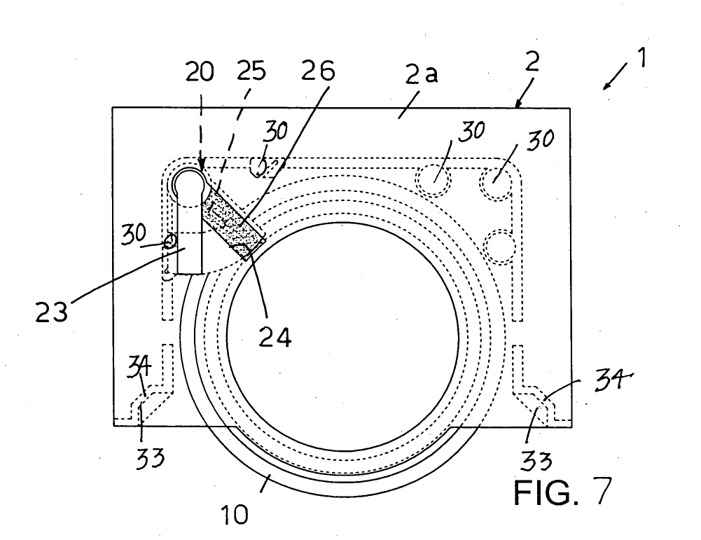

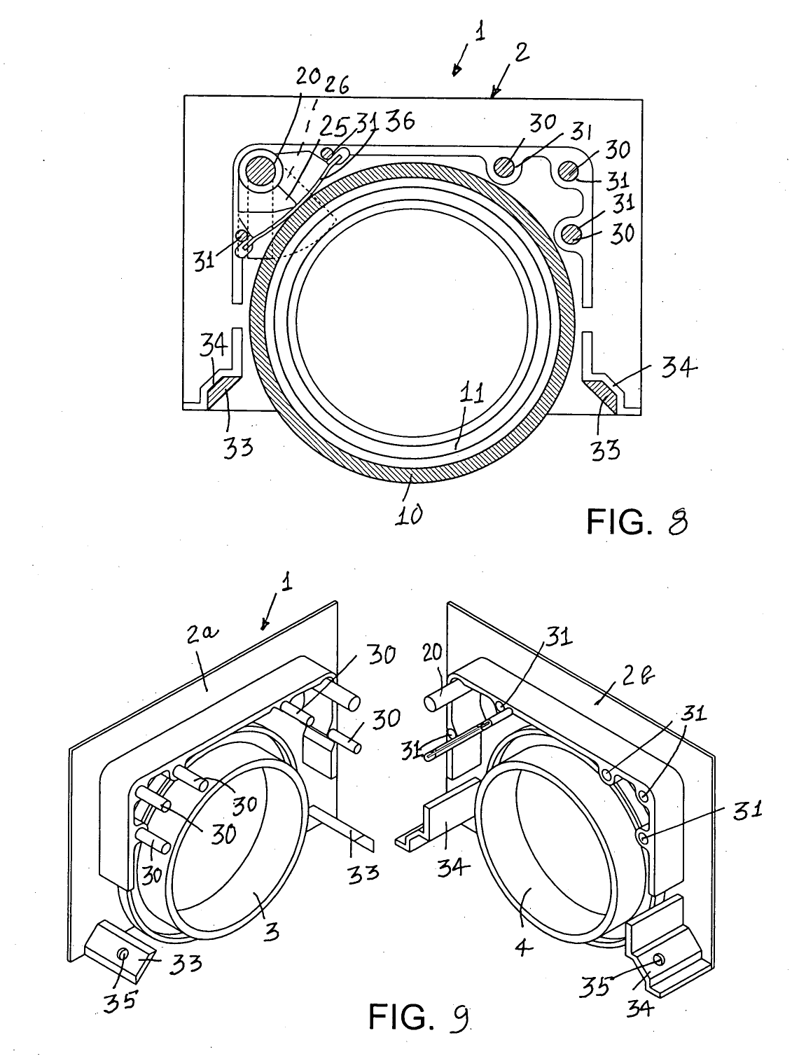

As shown in FIGS. 5 and 6, in a regular operation condition, the braking element 20 is arranged with its lever 23 located at the slot 24 and with the cam portion 25 being spaced from the wheel surface.

To brake the wheel, it is sufficient to rotatively drive the lever 23 to bring the cam element 25 to interfere against the wheel, while uncovering the slot 24, to show the red color of the band element 26, indicating the braked condition of the wheel.

The braking element 20 further comprises a built-in lamellar steel spring 36 operating to lock the wheel as the lever 23 brings the cam element 25 to interfere against the wheel.

From the above disclosure it should be apparent that the invention fully achieves the intended aim and objects.

In fact, the invention has provided a wheel construction which is structurally very compact, while comprising a large size hub, allowing to better distribute the operating forces, and allowing moreover the wheel to optimally slide, owing to the provision of the anti-friction ring element arranged between the annular band and the wheel hub.

In practicing the invention, the used materials, provided that they are compatible to the intended application, as well as the contingent size and shapes, can be any, depending on requirements.

1. A wheel construction, particularly for furniture and furnishing pieces, trolleys and the like, characterized in that said wheel construction comprises a box-like body including two half-shells adapted to be coupled to one another and defining a cylindric hub rotatably supporting an annular band providing a wheel construction sliding surface.

2. A wheel construction, according to claim 1, characterized in that said half-shells respectively define a first and second half-hubs adapted to be arranged in a mutually aligned relationship to provide said cylindric hub.

3. A wheel construction, according to claim 1, characterized in that said wheel construction comprises an anti-friction ring element arranged between said hub and annular band.

4. A wheel construction, according to claim 1, characterized in that said wheel construction comprises a braking element operating on the annular band.

5. A wheel construction, according to claim 1, characterized in that said braking element comprises a braking element body rotatably supported by a pin projecting from one of said half-shells, to said body being coupled an operating lever projecting through a slot defined through the other of said half-shells, a cam element operating on an outer surface of said annular band being moreover provided.

6. A wheel construction, according to claim 1, characterized in that said wheel construction further comprises a red colored indicating band which may be seen from said slot with the braking element in a braking condition thereof.

7. A wheel construction, according to claim 1, characterized in that said wheel construction comprises a braking element in which is built-in a lamellar steel spring operating to lock said wheel construction as said lever brings said cam element to interfere against said wheel construction.

8. A wheel construction, according to claim 1, characterized in that said wheel construction is constituted by a first male half-shell including projecting pegs and a second half-shell including corresponding recesses for engaging therein said pegs.

9. A wheel construction, according to claim 8, characterized in that said projecting pegs, with said wheel construction in an assembled condition, are engaged in said recesses thereby firmly clamping to one another said male half-shell and female half-shell.

10. A wheel construction, according to claim 8, characterized in that said pegs have a slightly conical configuration and, as they are engaged in their engaging recesses, provide, because of a clamping mechanical action of two equal materials thereof, a stable locking of said male and female half-shells.

11. A wheel construction, according to claim 1, characterized in that said wheel construction is assembled by pressing the male half-shell with respect to the female half-shell, without using assembling tools.

12. A wheel construction, according to claim 11, characterized in that said male half-shell comprises a plurality of projecting elements adapted to operate as abutments provided for sliding and engaging with contoured projecting elements thereby further stabilizing a connection of said two half-shells.

13. A wheel construction, according to claim 12, characterized in that said contoured projecting elements comprises corresponding holes for engaging therein clamping screws for clamping said wheel construction to a said furniture or furnishing pieces.

14. A wheel construction, according to claim 13, characterized in that said clamping screws provide an additional clamping element for additionally locking said two half-shells.
